(19) United States
(12) Patent Application Publication
(10) Pub. No.: US 2024/0039651 A1
(43) Pub. Date: Feb. 1, 2024

(54) RADIO TUNER SYSTEM USING METADATA AND METHOD THEREOF

(71) Applicant: Honda Motor Co., Ltd., Tokyo (JP)

(72) Inventor: Matt KOMICH, Denver, CO (US)

(21) Appl. No.: 17/875,241

(22) Filed: Jul. 27, 2022

(51) Int. Cl. H04H 60/73; H04H 60/43; H04B 1/405

(52) U.S. Cl. CPC H04H 60/73; H04H 60/43; H04B 1/405

(57) ABSTRACT

The present disclosure relates to radio stations. More particularly, this disclosure describes a radio tuner system using metadata that filters broadcasts based on metadata. Through this, the system may automatically identify those radio stations playing current content for a specific user. In one illustrative embodiment, a third-party server which provides on-demand music streaming services may provide the metadata. The metadata may be accessed and used to filter out those incoming broadcasts from the radio stations. Formats or other topics of the radio stations may be identified that fit user preferences identified within the metadata received from the third-party server and those broadcasts from the radio stations would be provided to the user. These identified broadcasts may then be output to an audio system.

### BACKGROUND

Advancements in data analytics and machine learning have enabled on-demand music streaming services to provide recommendations of new and old songs. The on-demand streaming service may collect user metadata associated with activities of a user on music application(s) managed by the service. Such activities may include, for example, a search history, a music purchase history, a browsing history, and the like. The metadata may further be used to collect information that pertains to a song file, such as an artist name, producer, writer, song title, release date, genre or track duration. This metadata, however, may be discounted or irrelevant towards traditional radio broadcasting. The two or more sources of audio content are typically separated by most in-vehicle telematics systems.

The present disclosure provides for a radio tuner system using metadata and method thereof that ties content together. Through this, the metadata from one source may be used to selectively provide radio broadcasting stations. Other benefits and advantages will become clear from the disclosure provided herein and those advantages provided are for illustration. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a system is provided. The system may include a receiver receiving a plurality of broadcasts. In addition, the system may include a processor unit identifying a broadcast from the plurality of broadcasts that corresponds to metadata received from a third-party service. The system may also include an output device for providing the broadcast.

In accordance with another aspect of the present disclosure, a computer program product having a non-transitory computer useable storage medium to store a computer readable program that, when executed on a computer, causes the computer to perform operations is provided. These operations may include identifying a broadcast from a plurality of broadcasts using metadata received from a third-party service. In addition, the operations may include providing the broadcast on an output device.

In accordance with yet another aspect of present disclosure, a vehicle system is provided. The vehicle system may include a radio frequency receiver receiving a plurality of broadcasts. In addition, the vehicle system may include an audio processor unit identifying a broadcast from the plurality of broadcasts using metadata received from a third-party service. The vehicle system may also include an output device for providing the broadcast.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a schematic diagram of an illustrative vehicle telematics display showing multiple audio feeds in accordance with one aspect of the present disclosure;

FIG. 2 is a schematic diagram of an exemplary vehicle having the vehicle telematics display in accordance with one aspect of the present disclosure;

FIG. 3 is a schematic diagram of an illustrative system for obtaining metadata from a third-party server in accordance with one aspect of the present disclosure;

FIG. 4 is a schematic diagram of an illustrative interface for an on-demand music streaming service in accordance with one aspect of the present disclosure;

FIG. 5 is a flow chart showing illustrative processes for accessing metadata from the third-party server in accordance with one aspect of the present disclosure;

FIG. 6 is a schematic diagram of an illustrative chart describing broadcasts within a geographic area in accordance with one aspect of the present disclosure;

FIG. 7 is a schematic diagram of an illustrative chart describing broadcasts with a “playing now” feature in accordance with one aspect of the present disclosure;

FIG. 8 is a schematic diagram of an illustrative chart describing broadcasts showing what is “playing now” in accordance with one aspect of the present disclosure;

FIG. 9 is a flow chart showing illustrative processes for selecting a broadcast from a plurality of broadcasts in accordance with one aspect of the present disclosure; and

FIG. 10 is a flow chart showing illustrative processes for identifying a broadcast from the plurality of broadcasts that corresponds to metadata received from a third-party service in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to radio stations. More particularly, this disclosure describes a radio tuner system using metadata that filters broadcasts. Through this, the system may automatically identify those radio stations playing current and relevant content for a specific user. In one illustrative embodiment, a third-party server which provides on-demand music streaming services may provide the metadata. The metadata may be accessed and used to filter those incoming broadcasts from the radio stations. Formats or other topics of the radio stations may be identified and matched with metadata received from the third-party server. These identified broadcasts may then be output to a speaker system.

Numerous other modifications or configurations to the radio tuner system will become apparent from the description provided below. For example, while the experience typically relates to audio from radio stations, other types of content may be realized as part of this system such as talk shows involving sports and other topics. Advantageously, the experience provided by this system may allow users to identify broadcasts from radio stations that are more in line with their already pre-established preferences. Other advantages will become apparent from the description provided below.

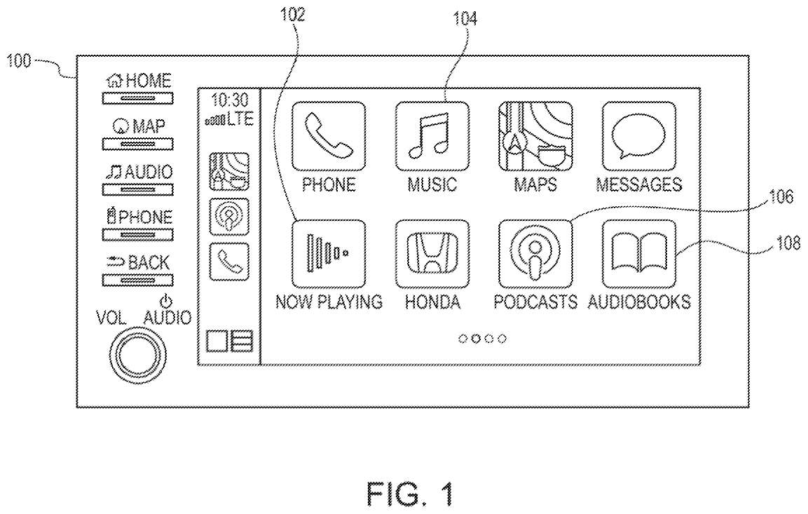

Turning to FIG. 1, a schematic diagram of an illustrative vehicle telematics display 100 showing multiple audio feeds in accordance with one aspect of the present disclosure is provided. The display 100 may be a component of an infotainment system controller that is included in a vehicle, the controller providing multiple entertainment and vehicle options. The display 100 may positioned in a dashboard of a vehicle where the driver and passengers may access infotainment options.

Through the infotainment system controller, and the multiple audio feeds, a system may be created to only provide radio stations that are currently playing tracks and talk radio in real-time that the driver and passengers may prefer. The radio tuner system using metadata may understand their music and podcast preferences and seek radio stations that are playing tracks in real-time that the system knows a driver may prefer. The radio tuner system using metadata may also seek talk radio stations that have ongoing conversations in real-time about topics that the driver wishes to hear. In an illustrative example, and as further detailed below, if the system recognizes through their on-demand audio listening history that the user listens to sports related podcasts and podcast episodes, the system may only recommend sports related talk radio stations in the event the driver is listening to and seeking radio stations. In this way, when a driver is actively seeking radio stations, only preferred stations may be played and non-preferred stations may be skipped. Through the different audio options, metadata detailing user preferences may be captured and analyzed for filtering radio broadcasts.

Multiple audio sources may exist and represented on the vehicle telematics display 100. A “Now Playing” button 102 may display an audio icon. The icon may represent the currently selected audio source. For example, an icon may represent that the vehicle is streaming on-demand music or audio is coming from a specific radio station. The audio information may include information about the currently active audio source, such as, but not limited to, the song currently playing, the artist currently playing, the frequency of the current station, the name of the current station, the name of the current program, phone number or contact name, call time, an error message, and volume feedback. Metadata may be captured regarding the source of the audio and what is being played.

When a “Music” button 104 is clicked, a selectable menu of audio sources opens. When audio information is clicked, the application associated with the current audio source may open. Audio sources may include, but are not limited to AM radio, FM radio, satellite radio, Internet radio, media files in a memory or database, user computer devices, external memory devices, CD player, tape player, DVD/Blu-ray player, phone, navigation systems, and a rear entertainment system (RES). Examples of media include, but are not limited to, music, books on tape, videos, movies, playlists, spoken instructions, phone calls, text and other messages, and any other media that may either be displayed, played, or projected to the user.

A “Podcast” button 106 may be provided on the telematics display 100 and also be used to capture metadata about the user's preference. The podcast may be a program made available in digital format for download over the Internet. For example, the podcast may be an episodic series of digital audio or video files that a user may download to a personal device to listen to at a time of their choosing. The button 106 may be used to fetch internally stored podcasts on the vehicle where a vehicle database may store the podcasts. Alternatively, the podcasts may be accessed via a smartphone where a separate application is run atop and wireless connectivity may be used to access the podcasts from a remote source or locally stored on the smartphone.

An “Audiobooks” button 108 may be used to access books that are recordings of a book or other work being read out loud. Metadata about the user's preferences may be captured from such audiobooks. The audiobooks may be retrieved locally or remotely similar to podcasts. The audiobooks may generally run longer and stopping and starting spots within the audiobook may be stored.

Through the different audio options, metadata detailing user preferences may be captured and analyzed for filtering radio broadcasts. In one illustrative example, metadata may be taken on what types of audiobooks are used from the “Audiobooks” button 108 and mix that information from podcasts selected under the “Podcast” button 106. Classical music may be a selection if the audiobook listened to is in the Baroque era and the user listens to news about that time period.

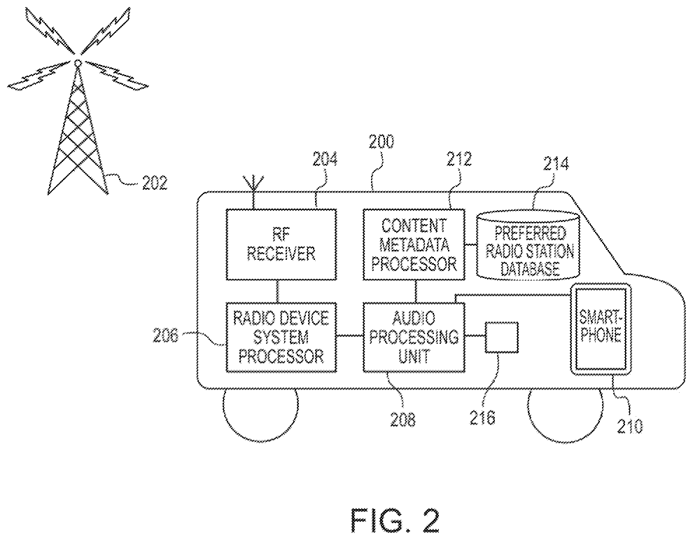

FIG. 2 is a schematic diagram of an exemplary vehicle 200 having the vehicle telematics display in accordance with one aspect of the present disclosure. The vehicle 200 is not limited to a sedan, sports utility vehicle, truck, or other traditional automobile. Rather, the vehicle 200 may be any other type of mobility device such as a camper, scooter, bicycle, and the like. Non-mobile devices, such as in-home audio systems, may also use similar concepts described herein. They may also be applied to smartphones or other personal devices where radio stations or broadcasts may be filtered.

Through the vehicle telematics display, radio stations 202 and other content may be received. The radio stations 202 may provide contact information such as phone numbers, Short Message Service (“SMS”) identifications, email addresses, Uniform Resource Locator (“URL”) links, and other contact information which may be organized based on the call sign (e.g., a unique identification of a radio station) or program identification code of each radio station. The contact information may reside on a remote server (e.g., a server at a mobile service provider) to which the vehicle 200 may be connected through a communications network.

After contact information of the radio station 202 is identified, a user interface (UI) may be displayed on the vehicle telematics display of the vehicle 200. In one example, a user interface having a call sign (e.g., “KIOE”), or alternatively a radio station name (e.g., “K103”) and a radio frequency (e.g., “FM 103.5”) of the radio station 202 may be displayed. Also displayed is information about the main content being played on the vehicle 200 (e.g., a name of a performer “Billy Idol,” a title of the song being played “Dreams,” etc.), and user interface for opening communication channels to the radio station 202. A user of the interface may tap or otherwise touch the vehicle telematics display to play the radio station 202.

The “radio station” 202 may be a system where content (e.g., audio content, visual content, and data) is transmitted from a transmitter as electromagnetic waves, to be received by an antenna on a radio frequency (“RF”) receiver 204. The term “radio broadcast” may refer to any transmission of content from a transmitter as electromagnetic waves. Thus, the term “radio broadcast” may include, for example, audio content broadcast, visual content (e.g., TV) broadcast, in digital or analog format, by land-based, mobile, or satellite radio stations. The simulcast from the radio station 202 may include main content (e.g., a music piece) and a data stream which may be modulated (e.g., converted from digital into analog form) and transmitted on a subcarrier (e.g., a separate signal carried on a main transmission). The data stream may contain information that includes a program type (e.g., news, drama, rock music, etc.), a program service name (e.g., the name of the radio station), and free-form information (e.g., radio text). The free-form information may be displayed on a display screen of a radio device system (“RDS”) enabled radio. The free-form information may contain one or more information snippets (e.g., text segments, compressed text, numeric values, etc.) that, when parsed and assembled, may indicate a title of the main content (e.g., a title of a song being played), a name of a performer of the main content (e.g., a name of an artist singing the song), etc. The information from the radio station 202 may be used to determine which to be used by the vehicle 200, and the vehicle telematics display when the user wishes to listen to a radio station 202.

The vehicle 200 may include one or more RF receivers 204. An RF receiver 204 may receive, for example, AM/FM broadcast or satellite broadcast (e.g., XM® or Sirius® radio broadcast). An RF receiver 204 may also be a TV tuner. In some implementations, an RF receiver 204 is built into the communication subsystems. In other implementations, an RF receiver 204 is an independent subsystem coupled to a mobile device (e.g., using a wired connection or a wireless connection).

The RF receiver 204 may include a RDS processor 206, which may process broadcast content (which may be relayed to an audio processing unit 206). The RF receiver 204 may be digitally tuned to receive broadcasts at various frequencies. The RF receiver 204 may have a scanning function that tunes up or down and pauses at a next frequency where broadcast content is available.

The vehicle 200, may include a radio frequency (“RF”) receiver 204 and a RDS processor 206 that may receive the main content and the data stream from the radio station 202. The RDS processor 206 may separate the subcarrier from the main content. The main content (e.g., a song) is sent to an audio processing unit 208 and may be played through one or more speakers 216 within the vehicle 200. The RDS processor 206 may demodulate the subcarrier to extract information snippets from the RDS broadcast. In a RDS broadcast, condition of signals received may vary greatly. For example, when the vehicle 200 is moving, the signal received may be poor due to interferences from various electronic components in the car as well as the location of the car (e.g., in a tunnel). The RDS processor 206 may have built-in error correction functions. However, the reliability of the built-in error correction mechanism may vary. Therefore, the extracted information snippets may be in pieces, instead of an entirety, of the original broadcast data stream.

The audio processing unit 208 may receive the content from the radio stations and may process it according to received metadata and user preferences. Numerous radio stations 202 may be supplied or provided to the audio processing unit 208 but not all should be provided to the user within the vehicle 200 and the vehicle telematics display. The audio processing unit 208 may work with a content metadata processor 212 to remove or limit the amount of radio stations 202 that are provided through the user interface and/or the vehicle telematics display. In essence, this would use the metadata from another source of content to adjust the radio stations 202.

The content metadata processor 212 may analyze and extract information from other sources or the same source. For example, metadata may be created based on the types of radio stations 202 that the user gravitates to. This may be noted through selections that the user makes. The user may have a preference to listen to “Religious”, “Top-40”, “Oldies”, “Sports”, etc. The extracted information may be stored in a content metadata data structure such as preferred radio station database 214. Content metadata may describe a broadcast and the content of the broadcast. The content metadata data structure may have multiple components (e.g., data fields) that corresponds to information fields contained in the RDS data. RDS data may contain various information fields such as clock time, program identification code, a program service name, a program type (e.g., PTY 10, which stands for “pop music” in RDS and “country” in RBDS), free-form information (e.g., radio text), etc. The content metadata components may each contain a corresponding RDS data field. The content metadata may also contain other components that describe the main content being broadcast (e.g., the name of the artist playing the song, the title of the song, etc.). The name, title, etc. may be extracted, for example, by analyzing the free-form information (e.g., radio text) field of the RDS data.

In some implementations, the content metadata processor 212 may process metadata information from the radio station 202 from reference data stored in a radio station database. The preferred radio station database 214 may be a database that contains one or more phone numbers, Short Message Service (“SMS”) identifications, email addresses, Uniform Resource Locator (“URL”) links, and other contact information which may be organized based on the call sign (e.g., a unique identification of a radio station) or program identification code of each radio station. The preferred radio station database 214 may reside on a remote server (e.g., a server at a mobile service provider) to which the mobile device may be connected through a communications network or locally on the vehicle 200 itself.

The content metadata processor 212 may also receive metadata from a smartphone 210. The smartphone 210 may interact with the audio processing unit 208 or the content metadata processor 212 to identify metadata that may be used to process and filter through the radio stations 202 that are incoming. The metadata from the smartphone 210 may be captured from other devices and is not limited to the smartphone 210. For example, metadata about user preferences may be captured from geographic regions, of where the user lives. More rural areas may include more country options, while urban areas may include more pop and hip hop stations.

Other factors for determining metadata may include vehicle parameters such as acceleration, speed, navigation, destinations, schedules, time of day, month, year, and the like. A definition of metadata in the context of music is the information embedded in an audio file that is used to identify the content. If the song file itself is the data, the metadata is the song title or artist name, the track length, the beats per minute (“BPM”), or genre. Metadata is effectively SEO (search engine optimization) for tracks, and also works as a useful catalogue management tool. In an illustrative embodiment, metadata may include a song and artist name, composer, year and genre, comments, and track and disc number.

Metadata may also be collected from third-party services that run on third-party severs. The smartphone 210 may be used to access these third party servers that have audio content. The metadata from these may be pulled from their database and used in combination with the audio processing unit 208 to identify those radio stations 202 that are most relevant to a user.

In an illustrative example, the smartphone 210 may pull in relevant metadata showing that the user likes “Oldies” and the audio processing unit 208 would take those radio stations 202 that are received by the RF receiver 204. The content within the particular radio station 202 may be checked, for example, specific artists or song titles albums, etc. This may be combined with information in the preferred radio station database 214 to select a proper radio stations 202 for the user.

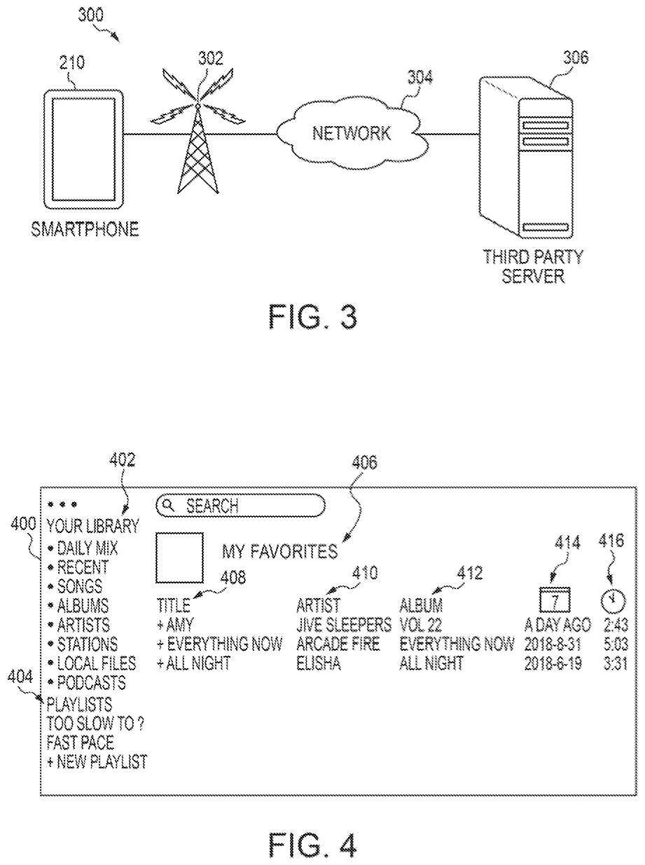

FIG. 3 is a schematic diagram of an illustrative system 300 for obtaining metadata from a third-party server 306 in accordance with one aspect of the present disclosure. The smartphone 210 may be used for obtaining metadata. Other systems and methods may be used to obtain metadata including downloading information through a transmission control unit (TCU) or wireless methods such as a local area network, personal area network, etc. This may occur over the network 304 and a third party server 306. The third party server 306 may include third party services such as on-demand music streaming services.

Regardless of where the metadata comes through, the purpose of these illustrations is to use that metadata to filter the radio stations that are incoming into the vehicle. The metadata may be used to filter other types of incoming audio content. For example, the metadata may come from user selections on the vehicle telematics display. Weather information may be used to provide metadata. In an example, a Beach Boys song may not be played when it is raining outside the vehicle.

As shown in the system 300, the smartphone 210 may connect with a cellular tower 302. A cellular network 304 may communicate with the tower 302 and a wide area network (WAN), such as the Internet, by use of a gateway. An access point device may provide communication access to the WAN. In some embodiments, both voice and data communications may be established over the cellular network 304 and the access point device. For example, the smartphone 210 may place and receive phone calls (e.g., using VoIP protocols), send and receive e-mail messages (e.g., using POP3 protocol), and retrieve electronic documents and/or streams, such as web pages, photographs, and videos, over the cellular network 304, gateway, and WAN (e.g., using TCP/IP or UDP protocols). Likewise, the smartphone 210 may place and receive phone calls, send and receive e-mail messages, and retrieve electronic documents over the access point device and the WAN. In some implementations, the smartphone 210 may be physically connected to the access point device using one or more cables and the access point device may be a personal computer. In this configuration, the smartphone 210 may be referred to as a “tethered” device.

Through its connection to the WAN, the smartphone 210 may retrieve and send communications to the third-party server 306. The third-party server 306 may host the on-demand streaming service where metadata may be stored. Other types of services provided by an on-demand streaming service may also store additional metadata.

With reference to FIG. 4, a schematic diagram of an illustrative interface 400 for an on-demand music streaming service in accordance with one aspect of the present disclosure is provided. The type of service from the third-party server may provide different services beyond audio to provide metadata. For example, metadata may be received from a movie streaming service or some type of profile service. These services may be paid for subscriptions or the like. Metadata may also be retrieved from cookies or browsing history. For example, if a user visits certain topics or content on the Internet, audio information may be inferred from that type of data. If the user is looking up rock history on their personal computer, this information may be used later on to receive and filter audio.

The shown interface 400 is for illustrative purposes and depicts an interface that may be used for on-demand music streaming services. Through the use of the various features and tabs on the interface 400, metadata may be generated. For example, the interface 400 may include a “Your Library” tab 402. Categories under this tab 402 may include “Daily Mix”, “Recent”, “Songs”, “Albums”, “Artists”, “Stations”, “Local Files”, and “Podcasts”, to name a few.

A “Playlists” tab 404 may also be provided within the interface 400. Playlists may be created by the user, for example, a “Too slow to Dance” may retain songs that dancing hip hop songs. A “Fast Pace” playlist may include those that are heavy rock songs. Under the “Playlists” tab 404, a user may be given an option to create a “New Playlist”. The interface 400 may provide click-and-drag operations allowing the user to create the new playlist and it may be stored under the “Playlists” tab 404.

Through the “Your Library” tab 402, “Playlists” tab 404, and other tabs that have not been shown, metadata may be created to determine preferences for the user. For example, favorite artists may be determined. Logic may be used to provide a new audio track for that specific artist, even though the track has never been listened to by that particular user. Genres may also be classified and similar sounding music within the genre may be gathered and processed within the metadata.

A “My Favorites” tab 406 may be provided as the introduction. This may be tuned into whenever the user logs into the on-demand music streaming service. The tab 406 may provide additional sub-tabs 408, 410, 412, and 414. These sub-tabs 408, 410, 412, and 414 in the “My Favorites” tab 406 may list the latest tracks played by the user. A “Title” sub-tab 408 may list the title, an “Artist” sub-tab 410 may list the artist, an “Album” sub-tab 412 may list the album, a “Recent” sub-tab 414 may show when the particular song was listened to last, and a “Time Frame” sub-tab 416 may indicate the duration of the song. The “My Favorites” tab 406 may indicate additional information as well which has not been shown.

The purpose of this interface 400 is to show different types of information that may be considered metadata. All the tabs, sub-tabs, and information within it may be used as metadata. Furthermore, machine learning (ML) or artificial intelligence (AI) may be used to determine what the metadata should be. For example, using artists names, a specific genre may be determined.

When on-demand, premium account audio listeners of a streaming service sign-up for a third party application, they may agree to give the third-party permission to view their account metadata during the sign-up process in order to begin using the service. Part of this permission is to allow view of the user's library of tracks, public and private playlists (that include both music and podcasts) and more. With this, the third-party service is able to understand the personal audio preferences of the driver and passengers.

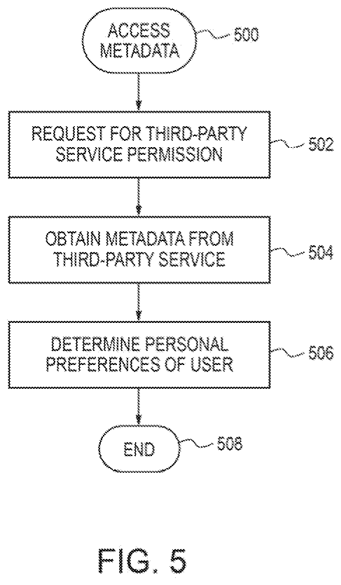

FIG. 5 is a flow chart showing illustrative processes for accessing metadata from the third-party server in accordance with one aspect of the present disclosure. Metadata may come from a variety of sources and is not limited to coming from the on-demand music streaming services. For example, metadata may come from social networking sites, on-vehicles systems, and the like. The metadata may show user preferences, and this could be in the past or in real-time. The processes for accessing metadata may begin at block 500.

At block 502, a request for a third-party service permission is sent to a third-party server. This third-party server may include any number of locations where metadata may be stored. In this illustrative example, the metadata may be related to audio content that is used to filter the incoming radio stations received by the RF receiver.

Metadata may be received from the third-party service at block 504. This information may be provided once the user has been verified or authenticated within the third-party server. For example, cookies may be used to enable automated authentication. Usernames and password combinations may also be used to authenticate the user such that the metadata may be sent back to the vehicle.

At block 506, personal preferences may be determined from the received metadata. This information may include what type of music the user likes, artists the user is into currently, or other pertinent information. Algorithms may parse the information from the received metadata to determine those preferences. In an example, the number of times a song and/or artist was listened to in the last week may be determinative of the user preferences. The processes may end at block 508.

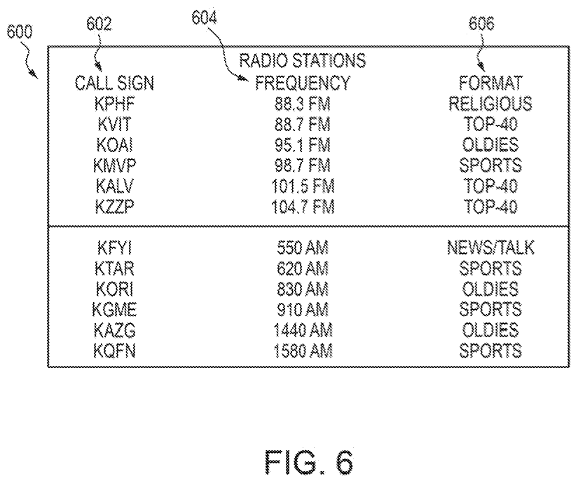

FIG. 6 is a schematic diagram of an illustrative chart 600 describing broadcasts within a geographic area in accordance with one aspect of the present disclosure. These broadcasts or radio stations may be defined by a call signal 602, frequency 604 and format 606. The call signal is the call sign that is a unique designation for a transmitting station. They may be formally assigned by a government agency, or informally adopted by individuals or organizations. In the illustrative example shown in the chart 600, twelve (12) different radio stations are shown.

The frequency 604 is the station frequency. FM is short for frequency modulation, which refers to the means of encoding the audio signal on the carrier frequency. FM full power, low power, translator and booster stations operate in the 88-108 MHz band. There are many classes of radio stations. FM broadcasting is a method of radio broadcasting using frequency modulation. AM broadcasting is radio broadcasting using amplitude modulation transmissions. It is used primarily for medium wave transmissions, but also on longwave and shortwave radio bands. Other types of radio stations may exist and may be outside the AM/FM frequency.

A radio format 606, as shown within the chart 600, aims to reach a more or less specific audience according to a certain type of programming, which may be thematic or general, more informative or more musical, among other possibilities. Radio formats are often used as a marketing tool and are subject to frequent changes. In one illustrative example, the radio stations may be classified as “Religion”, “Top-40”, “Oldies”, “Sports”, and the like. Other categories exist and those shown have been listed for brevity purposes.

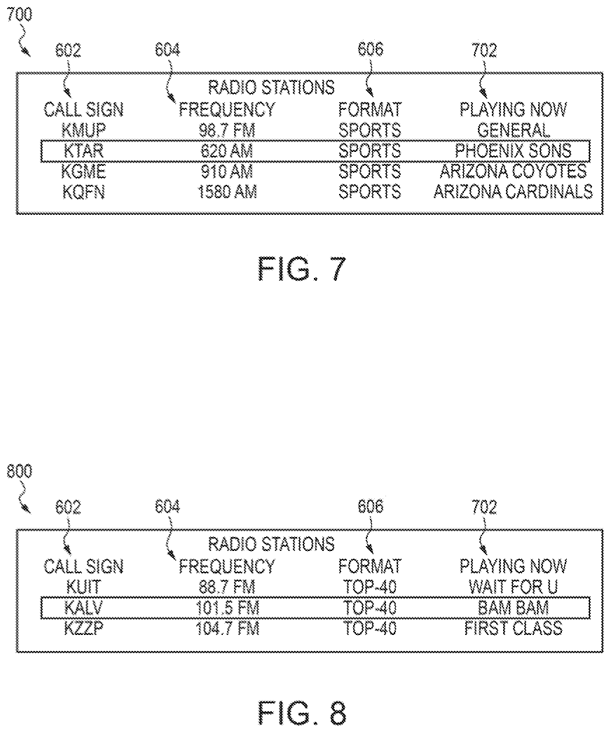

FIG. 7 is a schematic diagram of an illustrative chart 700 describing broadcasts with a “Playing Now” topic 702 in accordance with one aspect of the present disclosure. In addition, to the “Call Signal” 602, “Frequency” 604, and “Format” 606, “Playing Now” 702 may be listed on the chart 700. For an even more granularity, and to further define which radio station to select using the metadata, this column has now been added.

In an example, and as highlighted in the chart 700, the user may be interested in the Phoenix Suns. “Playing Now′ 702 may be used to further categorize the information. For example, and just by selecting those radio stations that fit the specific “Format” 606, four (4) sport stations may be selected. This may be hard to narrow down and in one embodiment, all four of the stations may be presented on a user interface. These may be shown visually. In one embodiment, the remaining stations may be cycled (played) until indicated (by a button press) to stop.

In the shown chart 700, however, the radio stations may even be further limited through what's ‘Playing Now” 702. The “Sports” stations may be identified and further condensed down to a single selection or selections that involve a certain topic that is playing now. In this example, the user may have metadata showing that they are interested in the Phoenix Suns. Accordingly, the radio station that shows a currently playing topic about sports and showing the Phoenix Suns would be provided through the audio system.

In one embodiment, other factors may be used, such as the length of programming left. For example, if there is not a lot of time left on the programming, the radio station may be skipped. The user may have a preference to listen to radio stations that have currently playing content that lasts for a predetermined threshold. A radio station, for example, may be played if there is between twenty (20) minutes and ten (10) minutes of playing time left.

In another example, the radio station may not be selected based on whether how much time has elapsed since the beginning of the playing of the audio content. If for example five (5) minutes has elapsed in a selected station, the metadata may determine that the user is no longer interested in the content. Advantageously, this may remove the radio stations that have started their content and it would be difficult to understand what is going on.

Other criteria that may be used to remove radio stations using metadata may include play time or how long the content is on air. In one embodiment, radio stations may be removed using the preferred radio station database. In this database, some stations even though they show the correct content, may not be liked by the user. This may be stored in the database or may be used as a user preference which was retrieved in the metadata.

In one embodiment, a radio station may be passed on if the content is played at a later time and/or date. For example, between the choice of a first content or a second content that will be played at a later date, the system may choose the first content. The user's schedule may also be considered when to postpone playing of the second content.

FIG. 8 is a schematic diagram of an illustrative chart 800 describing broadcasts showing what is “playing now” in accordance with one aspect of the present disclosure. “Call Signal” 602, “Frequency” 604, “Format” 606 and “Playing Now” 702 may be different from before as this may be a different user having their own unique metadata. This particular user may prefer the “Top 40” format 606. The system would filter the results from there homing in on the particular artist within the Top-40 as shown as selected within the chart 800.

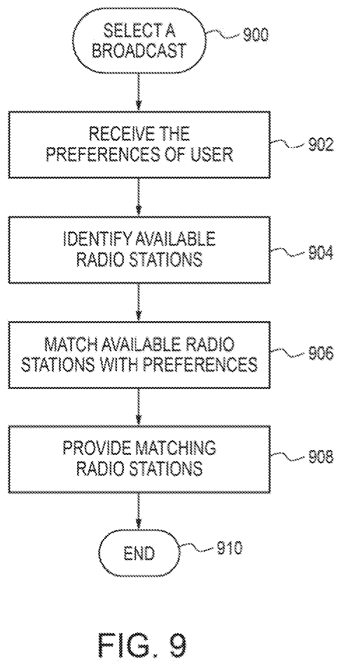

Turning to FIG. 9, a flow chart showing illustrative processes for selecting a broadcast from a plurality of broadcasts in accordance with one aspect of the present disclosure is provided. The processes are exemplary and for illustrative purposes only. This is one example of matching or identifying the particular broadcasts best suited for the particular user using metadata. The broadcasts or radio station that may be selected is based on the user preferences defined by the metadata. The processes may begin at block 900. The processes may begin at block 900.

At block 902, preferences are received regarding the particular user. This may be identified, as shown above, using metadata. The metadata may come from on-demand music streaming services and/or other areas where metadata about audio content preferences may be obtained. For example, vehicle data may be used with respect to navigation direction, weather conditions, etc.

Available radio stations may be identified using the received preferences at block 904. The radio stations may be accessed and received through the RF receiver. As shown in the charts above, a number of radio stations may be received and the system may filter those out based on the preferences.

At block 906, a sub-routine may be processed that matches or identifies available radio stations with preferences. That is, using the metadata to define the preferences, which radio stations would best fit the user. For example, does the user wish to listen to a certain format, or what is playing now. Further details will be described in the sub-routine below.

At block 908, the radio stations that were matched are now provided to the user. If more than one radio station, the matched radio stations may be scrolled over a period of time for the user to select which is the best radio station. If only one station matches, then the selection would go that particular station. If no stations exist that fit the metadata, the system may provide a next radio broadcast on a broader level. For example, if the specific content is not playing, then the system would play something in the same format. If no radio stations are identified from there, the next category may then be used. In one embodiment, FM stations may be preferred to AM stations. The processes may end at block 910.

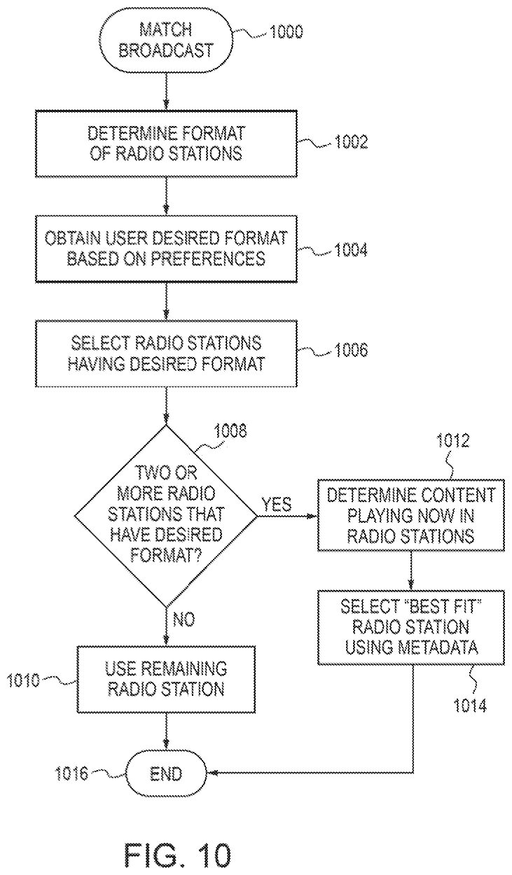

FIG. 10 is a flow chart showing illustrative processes for identifying a broadcast from the plurality of broadcasts that corresponds to metadata received from a third-party service in accordance with one aspect of the present disclosure. This is one subroutine that may be used for matching and identifying a broadcast that fits the user preferences but should not be construed as limiting. The processes may begin at block 1000.

At block 1002, a format for radio stations is determined. This includes receiving a list of radio stations from the RF receiver and identifying their particular format. The format for radio stations may include, but is not limited to, “Religious”, “Top-40”, “Oldies”, “Sports”, and the like. These may be defined in the metadata associated with a particular radio station.

At block 1004, a desired format may be obtained based on user preferences that may have been defined or extrapolated from metadata. This metadata may have come from a third-party server as described above. At block 1006, radio stations that fit or match the identified desired format are selected. For example, matching may occur based on the format of “Religious” or “Oldies”.

At decision block 1008, the processes may determine whether two or more radio stations have been selected. In one embodiment, if there are two or more radio stations then they may be scrolled or played before the user makes their selection. If there is only one radio station fitting the particular format, at block 1010, that particular radio station is provided via the audio system. The processes may end at block 1016.

If on the other hand, there are two radio stations that have the desired format, then at block 1012, the specific content that is currently playing may be identified by the system. At block 1014, a “best fit” radio station may be selected to determine which radio station to select. In one example, when a specific song is not played, the radio station may be playing another song by the artist. In another example of a “best fit”, the genre such as slow pop may be used to match the particular radio station with the user preferences. The processes may end at block 1016.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A system comprising:
a receiver receiving a plurality of broadcasts;
a processor unit identifying a broadcast from the plurality of broadcasts that corresponds to metadata received from a third-party service; and
an output device for providing the broadcast.

2. The system of claim 1, wherein the receiver is a radio frequency receiver.

3. The system of claim 1, wherein the plurality of broadcasts comprise of AM and FM broadcasts.

4. The system of claim 1, wherein the metadata received from a third-party service is transferred through a user device.

5. The system of claim 4, wherein the user device is a smartphone.

6. The system of claim 1, wherein the third-party service is an on-demand music streaming service.

7. The system of claim 1, wherein the metadata comprises at least one of an artist name, producer, writer, song title, release date, genre and track duration.

8. The system of claim 1, wherein identifying the broadcast from the plurality of broadcasts that corresponds to the metadata received from the third-party service comprises matching a corresponding format between the broadcasts and the metadata.

9. The system of claim 1, wherein identifying the broadcast from the plurality of broadcasts that corresponds to the metadata received from the third-party service comprises matching a topic between the broadcast and the metadata.

10. The system of claim 1, wherein the output device is an audio system.

11. A computer program product comprising a non-transitory computer useable storage medium to store a computer readable program that, when executed on a computer, causes the computer to perform operations comprising:
identifying a broadcast from a plurality of broadcasts using metadata received from a third-party service; and
providing the broadcast on an output device.

12. The computer program product of claim 11, wherein the broadcast is provided from a radio station.

13. The computer program product of claim 12, wherein the radio station operates from at least one of AM and FM broadcasts.

14. The computer program product of claim 11, wherein the computer readable program, when executed on the computer, causes the computer to perform operations to retrieve the metadata from a third-party service.

15. The computer program product of claim 11, wherein the metadata is a genre.

16. The computer program product of claim 11, wherein providing the broadcast on the output device comprises playing the broadcast on audio speakers.

17. A vehicle system comprising:
a radio frequency receiver receiving a plurality of broadcasts;
an audio processor unit identifying a broadcast from the plurality of broadcasts using metadata received from a third-party service; and
an output device for providing the broadcast.

18. The vehicle system of claim 17, wherein the plurality of broadcasts are from AM and FM broadcasts.

19. The vehicle system of claim 17, wherein identifying the broadcast from the plurality of broadcasts using the metadata comprises matching a format of the plurality of broadcasts with the metadata.

20. The vehicle system of claim 17, wherein the plurality of broadcasts are preferred stations.
